(19) United States
(12) Patent Application Publication
(10) Pub. No.: US 2015/0296434 A1
(43) Pub. Date: Oct. 15, 2015

(54) SYSTEMS, METHODS AND APPARATUS FOR OPTIMIZING MACHINE TO MACHINE DEVICE PERFORMANCE BY DYNAMICALLY VARYING SLOT CYCLE INDEX

(71) Applicant: QUALCOMM Incorporated, San Diego, CA (US)

(72) Inventors: Bhaskara Viswanadham Batchu, Medak, Ap. (IN); Rashid Ahmed Akbar Attar, San Diego, CA (US); Troy Russell Curtiss, Boulder, CO (US); Aditya Kailash Bohra, Hyderabad (IN)

(73) Assignee: QUALCOMM Incorporated, San Diego, CA (US)

(21) Appl. No.: 14/253,758

(22) Filed: Apr. 15, 2014

(51) Int. Cl. H04W 36/26; H04W 72/04; H04L 7/027; H04W 4/00; H04L 5/00

(52) U.S. Cl. CPC H04W 36/26; H04W 4/005; H04L 5/0048; H04L 7/027; H04W 72/0453

(57) ABSTRACT

Systems, methods and apparatus for optimizing machine-to-machine device performance are provided. In one aspect, a method comprises acquiring a pilot signal and determining a clock drift of the device based on the acquired pilot signal. The method further comprises selectively adjusting the frequency with which the device reacquires the pilot signal based at least in part on the determined clock drift. The slot cycle index is reduced when the determined clock drift is greater than a first predetermined fraction of a reacquisition window size. The slot cycle index is reduced when an anticipated clock drift of the device is greater than a second predetermined fraction of a reacquisition window size and the device fails to reacquire the pilot signal, the device is handed off, a finger energy is less than a first predetermined threshold, or a channel estimate value is less than a second predetermined threshold.

### BACKGROUND

1. Field

Certain aspects of the present disclosure generally relate to wireless communications, and more particularly, to systems, apparatus and methods for optimizing machine-to-machine (M2M) device performance by dynamically varying slot cycle index.

2. Background

In wireless communication networks, certain M2M devices transmit data to a base station occasionally and may not expect communications initiated by the base station for extended durations. Such devices may go to sleep in an effort to reduce average power consumption. From such a sleep state, the device may periodically wake up and determine a drift of its internal clock as compared to a pilot timing signal from the base station, which the device must reacquire. This clock drift is also called reacquisition slew. The sleep duration depends on a slot cycle index (SCI) value associated with the device. The greater the SCI, the longer the sleep duration. Generally, the longer the sleep duration is the greater the reacquisition slew will be. If the reacquisition slew is too large, the device will be unable to accurately track and reacquire the pilot timing signal from the base station. In such a case, the device will be required to perform a complete acquisition process before participating in network services again. This is costly in terms of both time and power consumption. Accordingly, to avoid reacquisition failure due to clock drift becoming too large, systems, apparatus and methods for optimizing device performance by dynamically varying slot cycle index are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method for optimizing machine-to-machine device performance. The method comprises acquiring a pilot signal. The method further comprises determining a clock drift of the device based on the acquired pilot signal. The method further comprises selectively adjusting the frequency with which the device reacquires the pilot signal based at least in part on the determined clock drift.

Another aspect of the disclosure provides a machine-to-machine device. The device comprises a receiver configured to acquire a pilot signal. The device further comprises a processor configured to determine a clock drift of the device based on the acquired pilot signal. The processor is further configured to selectively adjust the frequency with which the device reacquires the pilot signal based at least in part on the determined clock drift.

Another aspect of the disclosure provides a non-transitory computer-readable medium comprising code. The code, when executed, causes a machine-to-machine device to acquire a pilot signal. The code, when executed, further causes the device to determine a clock drift of the device based on the acquired pilot signal. The code, when executed, further causes the device to selectively adjust the frequency with which the device reacquires the pilot signal based at least in part on the determined clock drift.

Another aspect of the disclosure provides a machine-to-machine device. The device comprises means for acquiring a pilot signal. The device further comprises means for determining a clock drift of the device based on the acquired pilot signal. The device further comprises means for selectively adjusting the frequency with which the device reacquires the pilot signal based at least in part on the determined clock drift.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 is a diagram showing a conventional sleep and wake cycle where reacquisition of the network fails due to excessive reacquisition slew.

FIG. 4 is a diagram showing reduced slot cycle index-based sleep and wake cycles, according to an implementation.

FIG. 5 is a flow chart for decreasing the slot cycle index (SCI) of a machine-to-machine device, according to an implementation.

FIG. 6 is a functional block diagram of an exemplary machine-to-machine device, according to an implementation.

FIG. 7 is a chart illustrating a simulated number of times a stationary machine-to-machine device utilizes each of the SCI values while subjected to a clean channel, in accordance with some implementations.

FIG. 8 is another chart illustrating a simulated number of times a machine-to-machine device utilizes each of the SCI values while subjected to 1 kilometer per hour (km/hr) motion, in accordance with some implementations.

FIG. 9 is another chart illustrating a simulated number of times a machine-to-machine device utilizes each of the SCI values while subjected to 3 km/hr motion, in accordance with some implementations.

FIG. 10 is another chart illustrating a simulated number of times a machine-to-machine device utilizes each of the SCI values while subjected to 10 km/hr motion, in accordance with some implementations.

FIG. 11 is another chart illustrating a simulated number of times a machine-to-machine device utilizes each of the SCI values while subjected to 30 km/hr motion, in accordance with some implementations.

FIG. 12 is another chart illustrating a simulated number of times a machine-to-machine device utilizes each of the SCI values while subjected to 100 km/hr motion, in accordance with some implementations.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some implementations, a WLAN includes various devices which are the components that access the wireless network. For example, there may be two types of devices: access points (“APs” or “base stations”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, a wearable computing device (e.g., a smartwatch, a health or fitness tracker, etc.), an appliance, a sensor, a vending machine, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA may also be used as an AP.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a wearable computing device (e.g., a smartwatch, a health or fitness tracker, etc.), an appliance, a sensor, a vending machine, or any other suitable device that is configured to communicate via a wireless medium.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

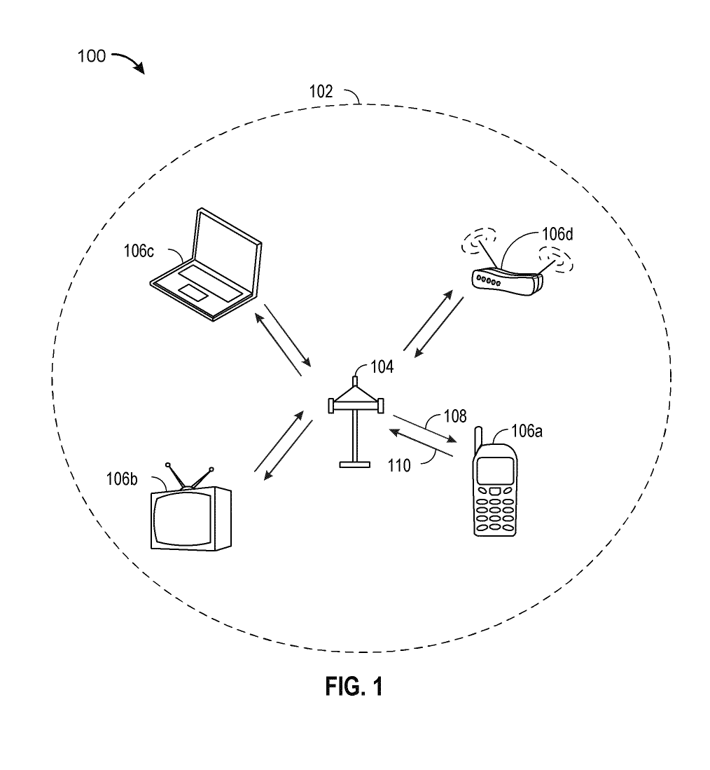

FIG. 1 illustrates an example of a wireless communication system 100 in which aspects of the present disclosure may be employed. The wireless communication system 100 may operate pursuant to a wireless standard, for example at least one of the 802.11ah, 802.11ac, 802.11n, 802.11g and 802.11b standards. The wireless communication system 100 may include an AP 104, i.e., BS 104, which communicates with one or more of STA 106a, 106b, 106c, and/or 106d (collectively referred to as STAs 106a-106d).

A variety of processes and methods may be used for transmissions in the wireless communication system 100 between the BS 104 and the STAs 106a-106d. For example, signals may be transmitted and received between the BS 104 and the STAs 106a-106d in accordance with OFDM/OFDMA techniques. If this is the case, the wireless communication system 100 may be referred to as an OFDM/OFDMA system. Alternatively, signals may be transmitted and received between the BS 104 and the STAs 106a-106d in accordance with CDMA techniques. If this is the case, the wireless communication system 100 may be referred to as a CDMA system.

A communication link that facilitates transmission from the BS 104 to one or more of the STAs 106a-106d may be referred to as a downlink (DL) 108, and a communication link that facilitates transmission from one or more of the STAs 106a-106d to the BS 104 may be referred to as an uplink (UL) 110. Alternatively, a downlink 108 may be referred to as a forward link or a forward channel, and an uplink 110 may be referred to as a reverse link or a reverse channel.

The BS 104 may provide wireless communication coverage in a basic service area (BSA) 102. The BS 104 along with the STAs 106a-106d associated with the BS 104 and that use the BS 104 for communication may be referred to as a basic service set (BSS). It should be noted that the wireless communication system 100 may not have a central BS 104, but rather may function as a peer-to-peer network between the STAs 106a-106d. Accordingly, the functions of the BS 104 described herein may alternatively be performed by one or more of the STAs 106a-106d.

In some circumstances, where one or more of the STAs 106a-106d do not communicate with the BS 104 frequently, the STAs 106a-106d may be configured to enter a sleep mode where one or more components of the STAs 106a-106d are powered down for a period of time in order to save energy. For ease of illustration, this may be described in more detail below with respect to the STA 106a. During paging channel (PCH) slotted mode operation, the STA 106a may enter a sleep mode having a duration determined based on a slot cycle index (SCI) value associated with the STA 106a. At the end of the duration the STA 106a may wake up from the sleep mode to receive and decode mobile-directed messages or to perform registrations with the BS 104. As per the CDMA standard, SCI values range from 0 to 7 and the sleep duration is calculated according to the following equation:

SLEEP DURATION=1.28*2^{SCI}seconds Eq. 1:

The SCI value the STA 106a utilizes is the minimum of the SCI value supported by both the STA 106a and the BS 104. As shown by Eq. 1 above, the larger the SCI value, the longer the sleep duration. In fact, each SCI value corresponds to a sleep duration twice as long as the next lower SCI value and half as long as the next higher SCI value. Accordingly, the STA 106a may consume significantly less power if its associated SCI value is higher than the commonly used lower SCI values, e.g., 0, 1 or 2.

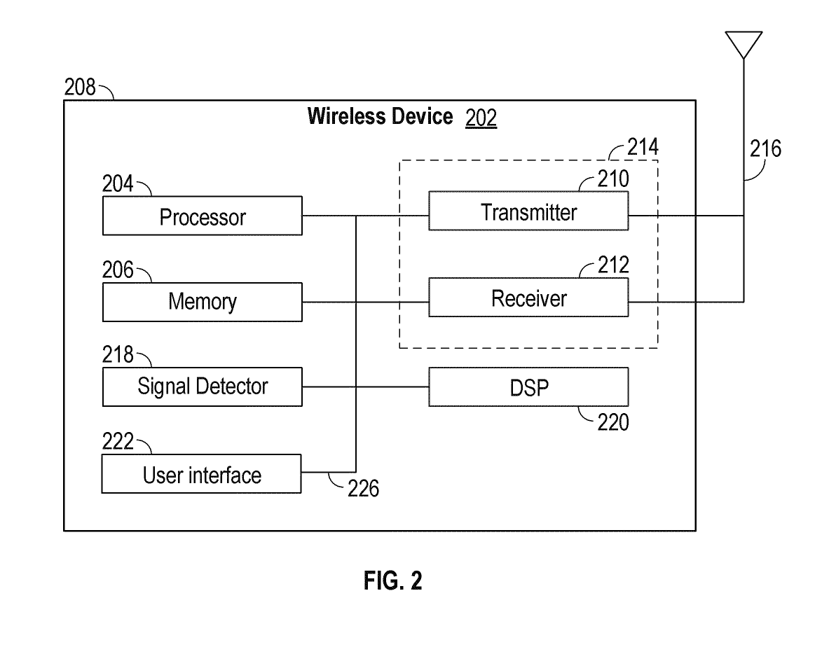

FIG. 2 illustrates various components that may be utilized in a wireless device 202 that may be employed within the wireless communication system 100. The wireless device 202 is an example of a device that may be configured to implement the various methods described herein. The wireless device 202 may comprise the BS 104 or one of the STAs 106a-106d.

The wireless device 202 may include a processor 204 which controls operation of the wireless device 202. The processor 204 may also be referred to as a central processing unit (CPU) or hardware processor. Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. Thus, where one or more operations are performed by the processor 204, the operations may be performed by a single processor 204, or alternatively a subset of the operations may each be performed by respective separate processors, which in combination form the processor 204. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include transitory or non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the wireless device 202 may comprise a BS 104 or any of the STAs 106a-106d, and may be used to transmit and/or receive communications. The communications exchanged between devices in a wireless network may include data units which may comprise packets or frames. In some aspects, the data units may include data frames, control frames, and/or management frames. Data frames may be used for transmitting data from a BS and/or a STA to other BSs and/or STAs. Control frames may be used together with data frames for performing various operations and for reliably delivering data (e.g., acknowledging receipt of data, polling of BSs, area-clearing operations, channel acquisition, carrier-sensing maintenance functions, etc.). Management frames may be used for various supervisory functions (e.g., for joining and departing from wireless networks, etc.).

Referring back to the STA 106a of FIG. 1, in order to stay synchronized with the BS 104, while awake the STA 106a receives a pilot timing signal from the BS 104. The STA 106a may keep its mobile pilot reference timer or clock aligned with this pilot timing signal. However, due to inherent inaccuracies between the STA's (106a) clock and the base station's (104) clock, while sleeping, the STA's clock may drift from the previous strongest pilot position (mobile pilot reference time). This clock drift is also called reacquisition slew. The STA 106a determines its reacquisition slew after waking up by searching the strongest pilot path using an active set window (ASET_WIN_SIZ) and comparing the pilot timing signal to the STA's clock. When the STA 106a operates with SCI values greater than 2, the STA 106a sleeps for relatively long periods of time. After such a long sleep cycle the STA 106a wakes up and attempts to reacquire the system, but due to a large reacquisition slew, i.e., clock drift, accumulated over the relatively long sleep duration the STA 106a may not be capable of reacquiring the system.

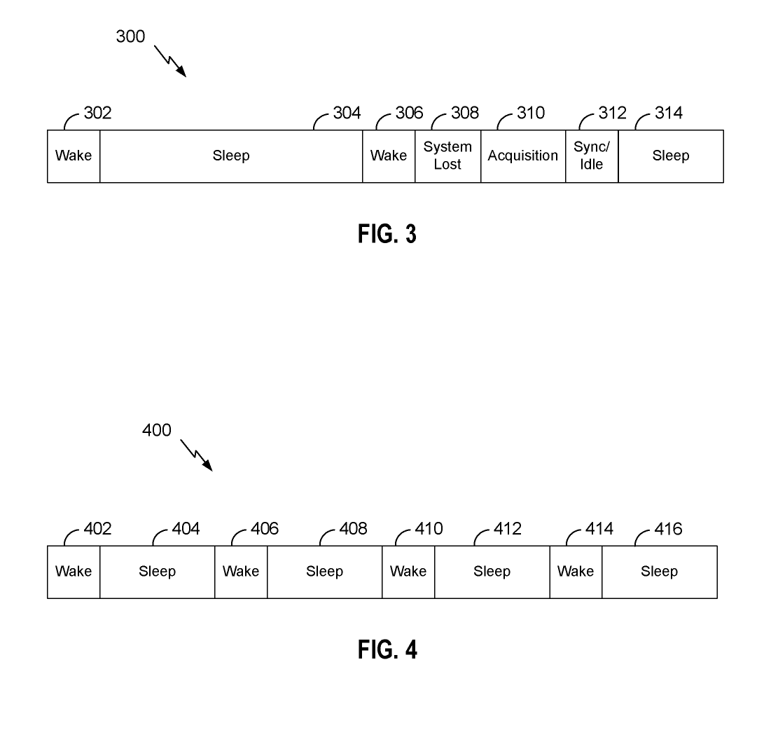

FIG. 3 is a diagram showing a conventional sleep and wake cycle where reacquisition of the network fails due to excessive reacquisition slew. Diagram 300 illustrates a wake interval 302 of a device, for example one of the STAs 106a-106d in FIG. 1. The device may enter a sleep mode for sleep interval 304. After the sleep interval 304, the device may wake up at a wake interval 306. However, due to the use of a relatively high SCI value, the sleep interval 304 is sufficiently long that the device is unable to maintain tracking of the pilot timing signal from the base station. This failure to reacquire the system causes the system to be lost during interval 308. Thus, the device must search for and reacquire the pilot timing signal from the base station, requiring the device to perform the lengthy and power consuming search and acquisition during acquisition interval 310. Once the pilot timing signal is again acquired, the device may enter a sync/idle interval 312 and may eventually enter a sleep mode again, for example, sleep interval 314. Operating with high SCI values allows the device to wake up less often, theoretically reducing power consumption. However, when the device is unable to reacquire the system after an excessively long sleep interval, average power consumption may actually increase due to the full pilot signal acquisition process as well as the associated extended period of time the device must stay awake. Thus, escalation to higher SCI values in order to save power without regard for the ability to reacquire the network may actually significantly reduce system performance in practice.

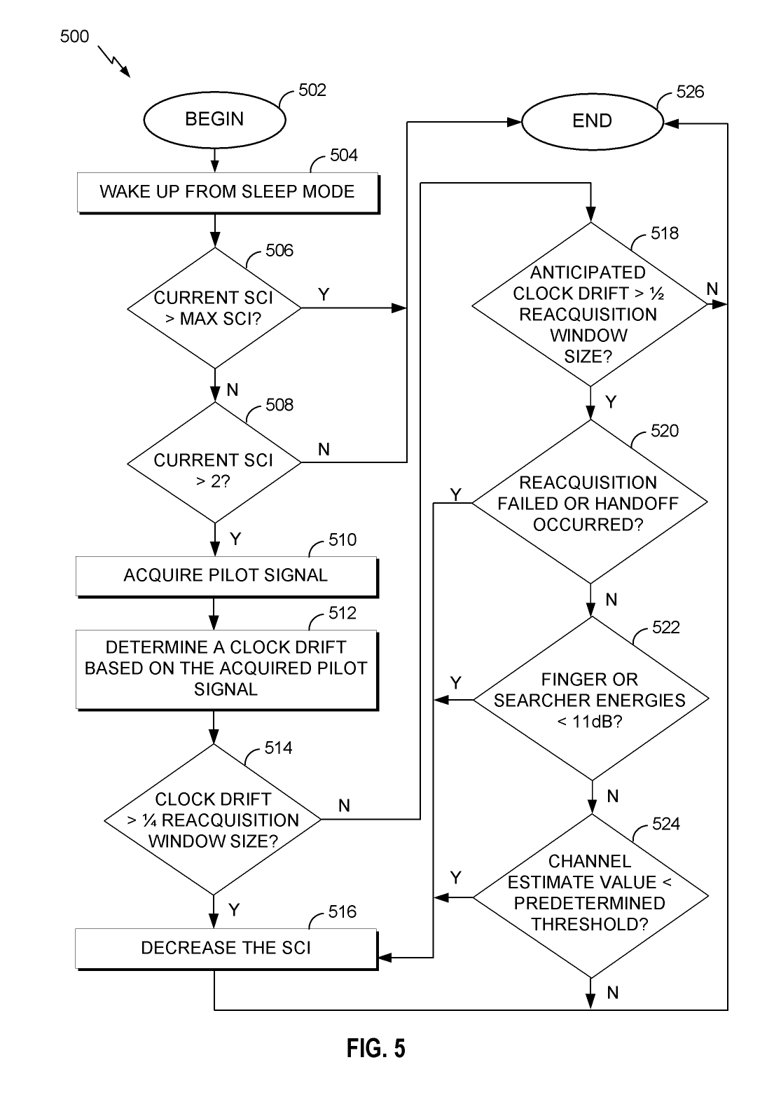

Contrarily, by providing a method and/or algorithm for utilizing lower SCI values under certain circumstances, it may be assured that reacquisition slew, i.e., clock drift, will be reduced comparatively. In such a case, other channel parameters are also far more likely to be favorable for the device to acquire the system quickly and successfully after waking up from a sleep cycle. FIG. 4 is a diagram 400 showing reduced slot cycle index-based sleep and wake cycles, according to an implementation. For example, diagram 400 illustrates wake intervals 402, 406, 410 and 414 of the device. However, contrary to diagram 300 of FIG. 3, the SCI value associated with the device may be dynamically reduced from a relatively high SCI value such that sleep intervals, e.g., sleep intervals 404, 408, 412 and 416, have reduced durations as compared to, for example, the sleep interval 304 of FIG. 3 associated with a higher SCI value. A process, method or algorithm for performing a reduction of the SCI value associated with a mobile device, for example the STA 106a of FIG. 1, will be described in more detail in connection with FIG. 5 below.

FIG. 5 is a flow chart for decreasing the slot cycle index of a machine-to-machine device, according to an implementation. In some implementations, one or more of the steps in flowchart 500 may be performed by, or in connection with, a processor and/or receiver, such as the processor 204 and the receiver 212 of FIG. 2, although those having ordinary skill in the art will appreciate that other components may be used to implement one or more of the steps described herein. As previously stated, the wireless device 202 of FIG. 2 may show any of the STAs 106a-106d in more detail. Accordingly, any of the STAs 106a-106d of FIG. 1 may perform the method described below. Although blocks may be described as occurring in a certain order, the blocks can be reordered, blocks can be omitted, and/or additional blocks can be added.

The flowchart 500 may begin with begin block 502. The method may continue to operation block 504, which may include waking up from a sleep mode. The sleep mode duration may have previously been determined based on a SCI value associated with the wireless device. Such a wake up may be initiated by a processor of the wireless device, for example, the processor 204 of the wireless device 202 of FIG. 2.

Once the wireless device is awake, the method may advance to operation block 506, which may include making a determination as to whether the current SCI value associated with the wireless device is greater than a maximum SCI value. For example, the maximum SCI value may be established by the base station, the network, or as the lesser of a maximum SCI value compatible with the base station and a maximum SCI value compatible with the wireless device. Such a maximum SCI value may be determined, for example at the wireless device 202, by the processor 204. If the determination is yes, the method my advance to end block 526. If the determination is no, the method may advance to operation block 508.

Operation block 508 may include determining whether the current SCI value is greater than 2. Since higher SCI values result in exponentially longer sleep durations and higher associated reacquisition slews, i.e., clock drifts, this algorithm may provide the greatest benefit when the current SCI value associated with the wireless device is greater than 2. However, the present application is no so limited and the SCI value against which the current SCI value is compared may be any value between 0 and 7 inclusive. Such a comparison may be made by the processor 204 in the wireless device 202 of FIG. 2, for example. If the determination is no, the method may advance to end block 526. If the determination is yes, the method may advance to operation block 510.

Operation block 510 may include acquiring the pilot signal. Such acquisition may be performed by the processor 204 of the wireless device 202 in FIG. 2, for example, and may additionally be performed utilizing the receiver 212, signal detector 218 and/or the DSP 220.

The method may advance to operation block 512, which includes determining a clock drift based on the acquired pilot signal. For example, the processor 204 may compare information in the acquired pilot signal with an internal clock, which may also be controlled by the processor 204 of the wireless device 202 to determine the clock drift.

The method may advance to operation block 514, which includes making a determination as to whether the clock drift is greater than ¼ of a reacquisition window size. The reacquisition window size may be the active set window (ASET_WIN_SIZ) as previously described. Although a value of ¼ is disclosed, the present application is not so limited and the value may be any predetermined fraction of the reacquisition window size. Such a determination may be made by the processor 204 of the wireless device 202 in FIG. 2, for example. If the determination is yes, the method may advance to operation block 516. If the determination is no, the method may advance to operation block 518.

Operation block 516 may include decreasing the SCI value associated with the wireless device. In some implementations, the SCI value may be decremented by one. However, the present application is not so limited and in at least some implementations the SCI value may be decremented by a number greater than 1. This operation may be performed by the processor 204 of the wireless device 202 in FIG. 2, for example. Thus, the decision to reduce the SCI value of the wireless device 202 may be made after the wireless device 202 wakes up. Although not shown, after decrementing the SCI value, the wireless device 202 may recalculate the sleep duration based on the new SCI value. The method may then advance to end block 526.

If it is determined that the current reacquisition slew is less than ¼ of the reacquisition window size, at operation block 518, a determination may be made as to whether an anticipated clock drift is greater than ½ of the reacquisition window size. Although a value of ½ is disclosed, the present application is not so limited and the value may be any predetermined fraction of the reacquisition window size. Such a determination may be made by the processor 204 of the wireless device 202 in FIG. 2, for example. If the determination is no, the method may advance to end block 526. If the determination is yes, the method may advance to operation block 520.

Operation block 520 includes determining whether the reacquisition failed or whether a handoff of the wireless device occurred. This determination may be performed by the processor 204 of the wireless device 202 in FIG. 2, for example. A determination of yes could indicate that the wireless device is not stationary. If in motion, the wireless device may benefit from utilizing a lower SCI value. Thus, if the determination is yes, the method may progress to operation block 516, where the SCI value is decreased. The method may then progress to end block 526. If the determination is no, the method may progress to operation block 522.

Operation block 522 includes determining whether a finger or searcher energy is less than 11 dB. Although an energy level of 11 dB is disclosed, the present application is not so limited and the energy level may be any predetermined threshold. This determination may be performed by the processor 204 of the wireless device 202 in FIG. 2, for example. If the determination is yes, the wireless device may benefit from utilizing a lower SCI value and the method may progress to operation block 516, where the SCI value is decreased. The method would then progress to end block 526. If the determination is no, the method may progress to operation block 524.

Operation block 524 includes determining whether a channel estimate value is less than a predetermined threshold. This determination may be performed by the processor 204 of the wireless device 202 in FIG. 2, for example. If the determination is yes, the wireless device may benefit from utilizing a lower SCI value and the method may progress to operation block 516, where the SCI value is decreased. The method may then progress to end block 526. If the determination is no, the method may progress directly to end block 524. In some implementations, where the method progresses to the end block 526 without having first decreased the SCI at operation block 516, the SCI may be increased in certain circumstances to reduce average power consumption of the wireless device.

Thus, the method(s) shown by flowchart 500 may be utilized to ensure the SCI value associated with a wireless device does not increase to a point where excessively long sleep durations cause clock drifts sufficient to prevent the wireless device from reacquiring the network. In this way, the method(s) shown by flowchart 500 optimize device performance with low power consumption by allowing the SCI value to remain high so long as the wireless device is still able to reacquire the network after sleeping, while avoiding the extended wake periods and power usage associated with reacquiring a lost network. This has the effect of maximizing sleep duration without loss of the network.

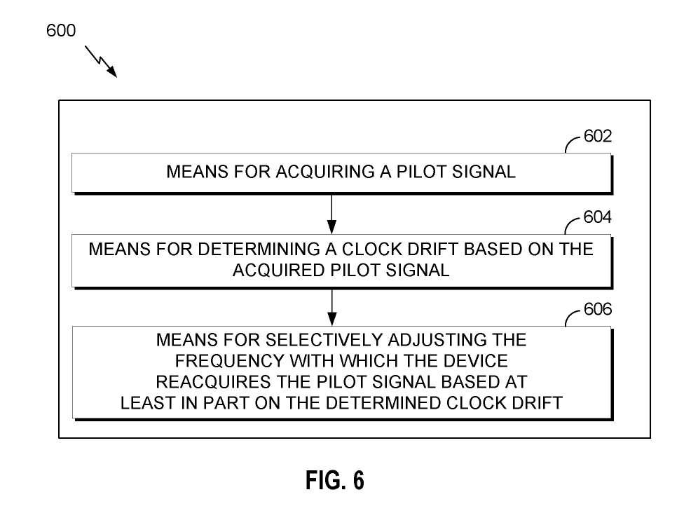

FIG. 6 is a functional block diagram of an exemplary machine-to-machine device 600, according to an implementation. Those skilled in the art will appreciate that the device 600 may have more components than illustrated in FIG. 6. The device 600 includes only those components useful for describing some prominent features of implementations within the scope of the claims. In some implementations, the device 600 may be configured to perform the method(s) as previously described in flowchart 500 in FIG. 5. The device 600 may comprise any of the STAs 106a-106d shown in FIG. 1, for example, which may be shown in more detail as the wireless device 202 shown in FIG. 2.

The device 600 comprises means 602 for acquiring a pilot signal. In some implementations, the means 602 can be configured to perform one or more of the functions described above with respect to block 510 of FIG. 5. The means 602 may comprise at least the receiver 212 and/or the processor 204 shown in FIG. 2, for example. In some implementations, the means 602 may additionally comprise the memory 206 shown in FIG. 2, for example.

The device 600 may further include means 604 for determining a clock drift based on the acquired pilot signal. In some implementations, the means 604 can be configured to perform one or more of the functions described above with respect to block 512 of FIG. 5. The means 604 may comprise at least the processor 204 shown in FIG. 2, for example. In some implementations, the means 604 may additionally comprise the memory 206 shown in FIG. 2, for example.

The device 600 may further include means 606 for selectively adjusting the frequency with which the device reacquires the pilot signal based at least in part on the determined clock drift. In some implementations, the means 606 can be configured to perform one or more of the functions described above with respect to blocks 514-524 of FIG. 5. The means 606 may comprise at least the processor 206 shown in FIG. 2, for example. In some implementations, the means 606 may additionally comprise the memory 206 shown in FIG. 2, for example. In some implementations, the device 600 may additionally include means for performing any steps or functions as previously described above in connection with FIG. 5.

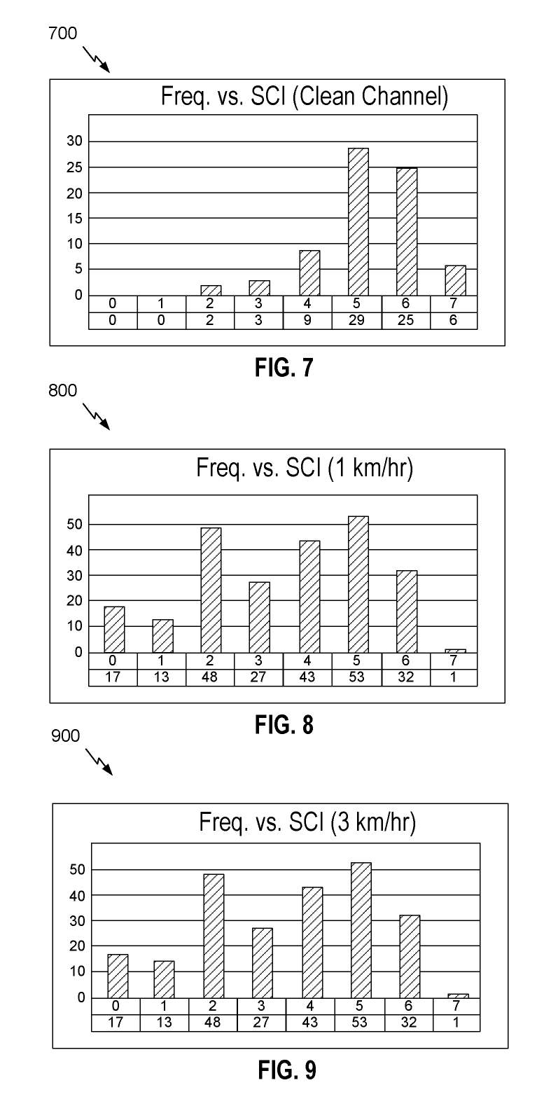

Simulated test results showing the efficacy of the method(s) previously described with respect to FIG. 5 will now be described for wireless devices under varied conditions in connection with FIGS. 7-12 below. FIG. 7 is a chart illustrating a simulated number of times a stationary machine-to-machine device utilizes each of the SCI values while subjected to a clean channel, in accordance with some implementations. In chart 700, it is assumed that the wireless device is stationary and experiencing a clean channel. Chart 700 shows the frequency distribution of the SCI value associated with a wireless device utilizing the method(s) disclosed above. Specifically, the chart 700 shows frequency of occurrence per hour of each SCI value between 0 and 7. For example, chart 700 shows that a stationary wireless device with a clean channel will have SCI values of 0 and 1 an average of zero times per hour, an SCI value of 2 twice per hour, an SCI value of 3 three times per hour, an SCI value of 4 nine times per hour, an SCI value of 5 twenty-nine times per hour, an SCI value of 6 twenty-five times per hour, and an SCI value of 7 six times per hour.

FIG. 8 is another chart illustrating a simulated number of times a machine-to-machine device utilizes each of the SCI values while subjected to 1 km/hr motion, in accordance with some implementations. For example, chart 800 shows that a wireless device moving with a speed of 1 km/hr will have an SCI value of 0 seventeen times per hour, an SCI value of 1 thirteen times per hour, an SCI value of 2 forty-eight times per hour, an SCI value of 3 twenty-seven times per hour, an SCI value of 4 forty-three times per hour, an SCI value of 5 fifty-three times per hour, an SCI value of 6 thirty-two times per hour, and an SCI value of 7 one time per hour.

FIG. 9 is another chart illustrating a simulated number of times a machine-to-machine device utilizes each of the SCI values while subjected to 3 km/hr motion, in accordance with some implementations. For example, chart 900 shows the same occurrence values for each of the SCI values 0 through 7 as described above regarding chart 800 of FIG. 8 for 1 km/hr motion.

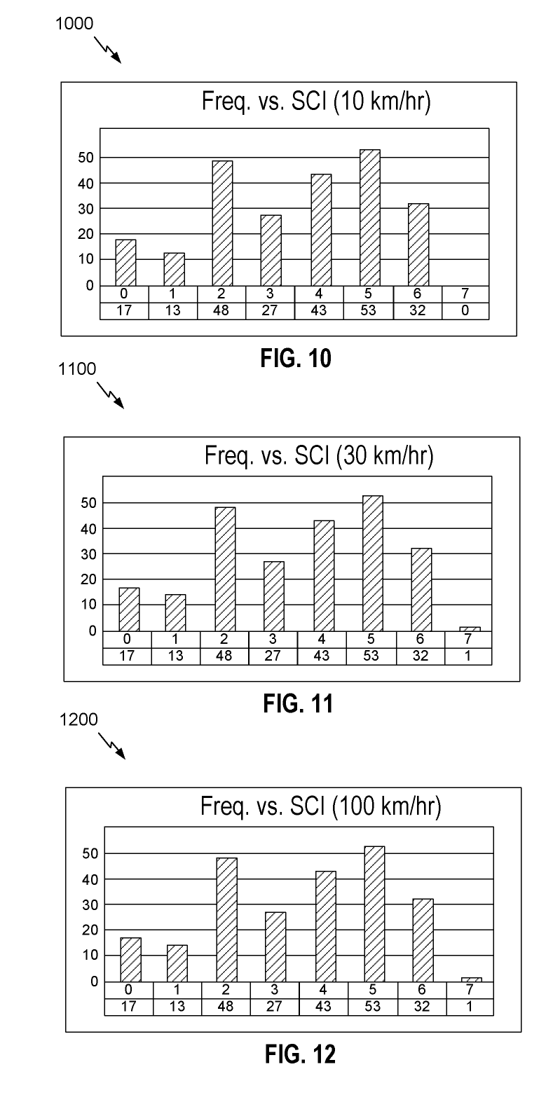

FIG. 10 is another chart illustrating a simulated number of times a machine-to-machine device utilizes each of the SCI values while subjected to 10 km/hr motion, in accordance with some implementations. For example, chart 1000 shows the same occurrence values for each of the SCI values 0 through 6 as described above regarding charts 700 and 800 of FIGS. 7 and 8 for 1 and 3 km/hr, respectively. However, chart 1000 shows that an SCI value of 7 occurs an average of zero times per hour.

FIG. 11 is another chart illustrating a simulated number of times a machine-to-machine device utilizes each of the SCI values while subjected to 30 km/hr motion, in accordance with some implementations. For example, chart 1100 shows the same occurrence values for each of the SCI values 0 through 7 as described above regarding charts 800 and 900 of FIGS. 8 and 9 for 1 and 3 km/hr, respectively.

FIG. 12 is another chart illustrating a simulated number of times a machine-to-machine device utilizes each of the SCI values while subjected to 100 kilometer per hour (km/hr) motion, in accordance with some implementations. For example, chart 1200 shows the same occurrence values for each of the SCI values 0 through 7 as described above regarding charts 800, 900 and 1100 of FIGS. 8, 9 and 11 for 1, 3 and 30 km/hr, respectively. Thus, as shown in each of FIGS. 7 through 12, the method(s) described above may allow a wireless device to maintain higher SCI values while channel conditions and reacquisition slew, i.e., clock drift, are such that the wireless device has a relatively high probability of reacquiring the network after the SCI-based sleep mode, while reducing the SCI values when there is a higher probability that excessive clock drift would cause the wireless device to lose the network.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method for optimizing machine-to-machine device performance, comprising:
acquiring a pilot signal;
determining a clock drift of the device based on the acquired pilot signal; and
selectively adjusting the frequency with which the device reacquires the pilot signal based at least in part on the determined clock drift.

2. The method of claim 1, wherein selectively adjusting the frequency comprises increasing the frequency.

3. The method of claim 1, wherein selectively adjusting the frequency comprises reducing a slot cycle index of the device.

4. The method of claim 3, wherein the slot cycle index is reduced when the determined clock drift is greater than a first predetermined fraction of a reacquisition window size.

5. The method of claim 4, wherein the first predetermined fraction is approximately one fourth of the reacquisition window size.

6. The method of claim 3, wherein the slot cycle index is reduced when an anticipated clock drift of the device is greater than a second predetermined fraction of a reacquisition window size.

7. The method of claim 6, wherein the slot cycle index is only reduced when one of the following occurs:
the device fails to reacquire the pilot signal;
a handoff of the device is performed;
a finger energy is less than a first predetermined threshold; and
a channel estimate value is less than a second predetermined threshold.

8. A machine-to-machine device comprising:
a receiver configured to acquire a pilot signal;
a processor configured to:
determine a clock drift of the device based on the acquired pilot signal; and
selectively adjust the frequency with which the device reacquires the pilot signal based at least in part on the determined clock drift.

9. The device of claim 8, wherein selectively adjusting the frequency comprises increasing the frequency.

10. The device of claim 8, wherein selectively adjusting the frequency comprises reducing a slot cycle index of the device.

11. The device of claim 10, wherein the processor is configured to reduce the slot cycle index when the determined clock drift is greater than a first predetermined fraction of a reacquisition window size.

12. The device of claim 11, wherein the first predetermined fraction is approximately one fourth of the reacquisition window size.

13. The device of claim 10, wherein the processor is configured to reduce the slot cycle index when an anticipated clock drift of the device is greater than a second predetermined fraction of a reacquisition window size.

14. The device of claim 13, wherein the processor is configured to reduce the slot cycle index only when one of the following occurs:
the device fails to reacquire the pilot signal;
a handoff of the device is performed;
a finger energy is less than a first predetermined threshold; and
a channel estimate value is less than a second predetermined threshold.

15. A non-transient computer-readable medium comprising code that, when executed, causes a machine-to-machine device to:
acquire a pilot signal;
determine a clock drift of the device based on the acquired pilot signal; and
selectively adjust the frequency with which the device reacquires the pilot signal based at least in part on the determined clock drift.

16. The non-transitory computer-readable medium of claim 15, wherein selectively adjusting the frequency comprises increasing the frequency.

17. The non-transitory computer-readable medium of claim 15, wherein selectively adjusting the frequency comprises reducing a slot cycle index of the device.

18. The non-transitory computer-readable medium of claim 17, wherein the code, when executed, causes the device to reduce the slot cycle index when the determined clock drift is greater than a first predetermined fraction of a reacquisition window size.

19. The non-transitory computer-readable medium of claim 18, wherein the first predetermined fraction is approximately one fourth of the reacquisition window size.

20. The non-transitory computer-readable medium of claim 17, wherein the code, when executed, causes the device to reduce the slot cycle index when an anticipated clock drift of the device is greater than a second predetermined fraction of a reacquisition window size.

21. The non-transitory computer-readable medium of claim 20, wherein the code, when executed, causes the device to reduce the slot cycle index only when one of the following occurs:
the device fails to reacquire the pilot signal;
a handoff of the device is performed;
a finger energy is less than a first predetermined threshold; and
a channel estimate value is less than a second predetermined threshold.

22. A machine-to-machine device comprising:
means for acquiring a pilot signal;
means for determining a clock drift of the device based on the acquired pilot signal; and
means for selectively adjusting the frequency with which the device reacquires the pilot signal based at least in part on the determined clock drift.

23. The device of claim 22, wherein selectively adjusting the frequency comprises increasing the frequency.

24. The device of claim 22 wherein selectively adjusting the frequency comprises reducing a slot cycle index of the device.

25. The device of claim 24, wherein the means for selectively adjusting is configured to reduce the slot cycle index when the determined clock drift is greater than a first predetermined fraction of a reacquisition window size.

26. The device of claim 25, wherein the first predetermined fraction is approximately one fourth of the reacquisition window size.

27. The device of claim 24, wherein the means for selectively adjusting is configured to reduce the slot cycle index when an anticipated clock drift of the device is greater than a second predetermined fraction of a reacquisition window size.

28. The device of claim 27, wherein the means for selectively adjusting is configured to reduce the slot cycle index only when one of the following occurs:
the device fails to reacquire the pilot signal;
a handoff of the device is performed;
a finger energy is less than a first predetermined threshold; and
a channel estimate value is less than a second predetermined threshold.

29. The device of claim 22, wherein:
the means for acquiring the pilot signal comprises a receiver;
the means for determining the clock drift comprises a processor; and
the means for selectively adjusting comprises the processor.
